(19) United States
(12) Patent Application Publication
(10) Pub. No.: US 2020/0096820 A1
(43) Pub. Date: Mar. 26, 2020

(54) OPTICAL SHEET AND BACKLIGHT

(71) Applicant: SHARP KABUSHIKI KAISHA, Sakai City, Osaka (JP)

(72) Inventors: HIROTOSHI YASUNAGA, Sakai City, Osaka (JP); HISASHI WATANABE, Sakai City, Osaka (JP); YOUZOU KYOUKANE, Sakai City, Osaka (JP)

(21) Appl. No.: 16/495,340

(22) PCT Filed: Mar. 15, 2018
(86) PCT No.: PCT/JP2018/010304

§ 371 Date: Sep. 18, 2019

(30) Foreign Application Priority Data
Mar. 22, 2017 (JP) 2017-056255

(51) Int. Cl. G02F 1/1335; F21V 9/08; F21K 9/68

(52) U.S. Cl. CPC G02F 1/133603; F21V 9/08; G02F 1/133611; F21K 9/68; G02F 1/133606

(57) ABSTRACT

An optical sheet and backlight that can readily suppress occurrence of uneven chromaticity in a case of providing a white-color printed pattern are provided. A white-color printed pattern is provided on a light-transmitting sheet of an optical sheet to transmit or reflect light from a light source. The printed pattern is made up of at least three layers of a lower printed layer, a middle printed layer, and an upper printed layer that are layered in order on the light-transmitting sheet. Each color tone of the lower printed layer and the upper printed layer is white. A color tone of the middle printed layer is a color different from white.

### TECHNICAL FIELD

The present invention relates to an optical sheet provided with a white-color printed pattern, and a backlight, and more particularly relates to a local dimming backlight, and an optical sheet used in the local dimming backlight.

### BACKGROUND ART

Displays are used in various electronic equipment, such as televisions, PCs, cellular phones, smartphones, tablets, digital cameras, automotive navigation, and so forth, and are indispensable for everyday life.

High contrast is an important capability of displays, and local dimming backlights, for example, are known as one technique to improve contrast of displays.

Local dimming backlights are backlights in which. area driving of the display can be performed. Local dimming backlights are not only advantageous in realizing high-contrast displays, but also have the benefit of enabling reduction in electrical power consumption, since the backlight is turned off in regions where light is not necessary.

Many local dimming backlights have a structure where LEDs are disposed within active areas of a display. LEDs appear as hotspots in such structures, resulting in a backlight with pronouncedly uneven brightness.

One conceivable measure to deal with this problem is to provide a printed pattern of white paint directly above the LEDs, for example. A great part of the light is diffusely reflected at the white paint, and also reflected at a reflection sheet provided below, in this configuration. Accordingly, a great part of the light is reused. The shielding area ratio of the white paint is made to be high at portions where brightness is high, while on the other hand the shielding area ratio is made to be low at portions where brightness is low. This enables the backlight brightness distribution. to be made uniform.

A uniform-brightness sheet disclosed in PTL 1, for example, is known as a sheet where this type of printed pattern has been formed.

A uniform-brightness sheet 100 disclosed in PTL 1 has a white-color diffusion layer 102 that makes incident light having an uneven brightness distribution to be uniform and emits the light, formed on at least one face of a transparent base material 101 by pattern printing, as illustrated in FIG. 12. Assuming that the transmittance of rays 436 nm in wavelength is 1, the transmittance of the white-color diffusion layer 102 falls within a range of 0.8 to 1.6 for transmittance of rays 544 nm in wavelength and 612 nm in wavelength.

From the perspective of color tone imbalance, it is thought that transmittance of rays 544 nm in wavelength and 612 nm in wavelength ideally would be suitable to be 1.0 in the first glace, but there are cases where it is preferable to perform adjustment depending on the color tone of the light source and the color tone of ink used for printing. Thus, it is asserted that the uniform-brightness sheet 100 can control color tone of emitted light well, by employing the above-described configuration.

### CITATION LIST

### Patent Literature

PTL 1: Japanese Unexamined Patent Application Publication “Japanese Unexamined Patent Application Publication No. 2010-185906 (Published Aug. 25, 2010)”

### SUMMARY OF INVENTION

### Technical Problem

Now, the above-described conventional uniform-brightness sheet 100 is an arrangement where correction of uneven chromaticity by tinge adjustment of a coated layer made up of one layer is performed for the entirety of paint used for the printed pattern.

However, attempting to perform correction of uneven chromaticity by tinge adjustment of a coated layer made up of one layer for the entirety of paint used for a printed pattern results in slight tinge change of paint leading to marked change in backlight chromaticity. Accordingly, extremely minute tinge adjustment is necessary in a case of preparing the entirety of paint used for the printed pattern made up of one layer, and adjustment is difficult. Consequently, there is a problem that unevenness in chromaticity readily occurs.

The present invention has been made in light of the above-described conventional problem, and accordingly it is an object thereof to provide an optical sheet and backlight that can readily suppress occurrence of uneven chromaticity in a case of providing a white-color printed pattern.

### Solution to Problem

In order to solve the above problem, an optical sheet according to an aspect of the present invention is an optical sheet where a white-color printed pattern is provided on a light-transmitting sheet to transmit or reflect light from a light source. The printed pattern is made up of at least three layers of a lower printed layer, a middle printed layer, and an upper printed layer that are layered in order on. the light-transmitting sheet. Each color tone of the lower printed layer and the upper printed layer is white, and a color tone of the middle printed layer is a color different from white.

In order to solve the above problem, a backlight according to as aspect of the present invention includes multiple light sources that are disposed immediately below a display panel and that emit white light, and the optical sheet provided at an emission face side of the light source across an air layer.

### Advantageous Effects of Invention

According to an aspect of the present invention, advantages can be obtained where an optical sheet and backlight can be provided that can readily suppress occurrence of uneven chromaticity in a case of providing a white-color printed pattern.

### BRIEF DESCRIPTION OF DRAWINGS

FIG. 1 is a sectional view of principal portions, illustrating the configuration of a printed pattern on an optical sheet of a backlight according to Embodiment 1 of the present invention.

FIG. 2 (a) is a sectional view of principal portions illustrating the entire configuration of the backlight, (b) is a planar view of principal portions illustrating the entire configuration of the backlight, and (c) is a planar view of principal portions illustrating the printed pattern on the optical sheet of the backlight.

FIG. 3 is a sectional view of principal portions, illustrating the configuration of a printed pattern of a modification on the optical sheet of the backlight according to Embodiment 1 of the present invention.

FIG. 4 is a sectional view of principal portions, illustrating the configuration of the printed pattern of the modification on the optical sheet, illustrating the amount of transmission of light.

FIG. 5 is a sectional view of principal portions, illustrating the configuration of a printed pattern of another modification on the optical sheet of the backlight according to Embodiment 1 of the present invention.

FIG. 6 is a sectional view of principal portions, illustrating the configuration of a printed pattern on an optical sheet of a backlight according to Embodiment 2 of the present invention.

FIG. 7 is a sectional view of principal portions, illustrating the configuration of a printed pattern of a modification on the optical sheet of the backlight according to Embodiment 2 of the present invention.

FIG. 8 is a sectional view of principal portions, illustrating the configuration of a printed pattern of another modification on the optical sheet of the backlight according to Embodiment 2 of the present invention.

FIG. 9 is a sectional view of principal portions, illustrating the basic configuration of a printed pattern on an optical sheet of a backlight according to Embodiment 3 of the present invention.

FIG. 10 is a sectional view of principal portions, illustrating the configuration of the printed pattern based on a relation with a light source in the optical sheet of the backlight.

FIG. 11 is a sectional view of principal portions, illustrating the configuration of a printed pattern of a modification on the optical sheet of the backlight according to Embodiment 3 of the present invention.

FIG. 12 is a sectional view illustrating the configuration of an optical sheet according to a conventional example.

### DESCRIPTION OF EMBODIMENTS

### Embodiment 1

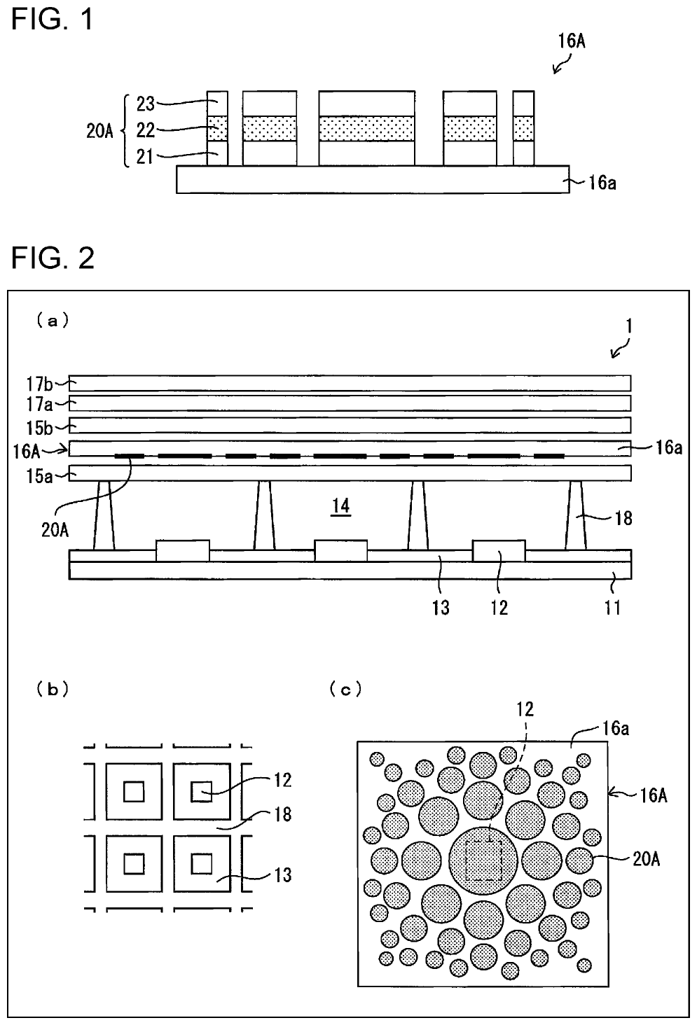

The following is a description of Embodiment 1 of the present invention with reference to FIG. 1 through FIG. 5.

An optical sheet according to the present embodiment is provided to a local dimming backlight, i.e., to a direct backlight. Local dimming backlights are also applied to various displays, such as in televisions, PCs, cellular phones, smartphones, tablets, digital cameras, automotive navigation, and so forth, for example. A liquid crystal display device, for example, is preferable for the display.

### Configuration of Backlight

The configuration of a backlight 1 having an optical sheet 16A according to the present embodiment will be described with reference to (a), (b), and (c) in FIG. 2. (a) in FIG. 2 is a sectional view of principal portions illustrating the entire configuration of the backlight 1. (b) in FIG. 2 is a planar view of principal portions illustrating the configuration of the backlight 1 excluding the portions from a lower-side diffusion sheet 15a and above. (c) in FIG. 2 is a planar view of principal portions illustrating a printed pattern 20A on the optical sheet 16A of the backlight 1.

The backlight 1 according to the present embodiment is a direct backlight, as mentioned. above. Accordingly, a liquid amount display panel, for example, that is omitted from illustration, exists at the upper side of the backlight

The backlight 1 has an LED substrate 11 on which are mounted LEDs 12 and a reflection sheet 13, as illustrated in (a), (b), and (c) in FIG. 2. A lower-side diffusion sheet 15a, the optical sheet 16A, an upper-side diffusion sheet 15b, a lower-side lens sheet 17a, and an upper-side lens sheet 17b, are layered in this order above the LED substrate 11, across an air layer 14. Note that the backlight 1 does not have to be layered in this order. For example, while two layers of the lower-side lens sheet 17a and upper-side lens sheet 17b are provided in the present embodiment, there are case where the lens sheet is one layer.

Frames 18 for maintaining the spacing between the LED substrate 11 and the lower-side diffusion sheet 15a are formed in the air layer 14. Note that there are cases where the frame 18 does not exist, for example. The frame 18 is formed in a grid form as illustrated in (b) in FIG. 2, with one LED 12 each disposed inside each grid. The reflection sheet 13 on the LED substrate 11 is disposed overall, surrounding the LED 12.

The LED 12 emits white light in the present embodiment. The lower-side diffusion sheet 15a and upper-side diffusion sheet 15b are formed of a milky white sheet, for example, uniformly diffusing light from the LEDs 12. The lower-side lens sheet 17a and upper-side lens sheet 17b each have mutually-orthogonal prism arrays, for example, that are omitted from illustration. High-brightness light is emitted is a desired viewing angle direction by the combination of the lower-side lens sheet 17a and upper-side lens sheet 17b.

The optical sheet 16A according to the present embodiment has the printed pattern 20A formed on a light-transmitting sheet 16a, as illustrated in (a) and (c) in FIG. 2. The light-transmitting sheet 16a is made of a transparent acrylic sheet, for example. The printed pattern 20A is coated on the light-transmitting sheet 16a, and is formed in three layers, for example.

Note that the optical sheet 16A according to the present embodiment has the printed pattern 20A formed on the LED 12 side of the light-transmitting sheet 16a. However, this is not necessarily restrictive in the optical sheet 16A. according to an aspect of the present invention, and the printed pattern 20A may be formed on the opposite side of the light-transmitting sheet 16a from the LED 12 side.

### Printed Pattern of Optical Sheet

The detailed configuration. of the printed pattern 20A of the optical sheet 16A according to the present embodiment will be described with reference to FIG. 1. FIG. 1 is a sectional view of principal portions, illustrating the configuration of the printed pattern 20A on the optical sheet 16A of the backlight 1 according to the present embodiment.

Many conventional local dimming backlights have a structure where LEDs are disposed within active areas. The LEDs appear as hotspots in such structures, resulting in a backlight with pronouncedly uneven brightness. One conceivable measure to deal with this is to provide one layer of a printed pattern of white paint directly above the LEDs. Accordingly, a great part of the light is diffusely reflected at the white paint, and also reflected at the reflection sheet 13 provided below, and is reused. The white paint is coated such that the shielding area ratio is high at portions where brightness is high, and the shielding area ratio is low at portions where brightness is low, as illustrated in (c) in FIG. 2. This enables the backlight brightness distribution to be made uniform.

Now, in a case where a printed pattern of one layer of white paint is provided, there will be occurrence of light that is reflected at the white paint many times, and light that is transmitted through the white paint many times. Accordingly, if the reflectance or transmittance of the white paint is slightly deviated from white, the chromaticity changes by light being reflected or transmitted many times. Also, the number of times that the light emitted from the LEDs is transmitted through or reflected at the printed pattern differs depending on the location in the backlight. As a result, uneven chromaticity occurs in the backlight. For example, there are cases where yellow chromatic unevenness occurs due to white light being reflected or transmitted by white paint multiple times.

In this case, in order to resolve the yellow chromatic unevenness, the uneven chromaticity can be corrected by using a white with a bluish tinge, which is in a complementary color relation as to yellow chromaticity. However, extremely fine tinge adjustment becomes necessary in a case of correction of uneven chromaticity by such tinge adjustment of a coated layer being performed for the entirety of paint of a printed pattern made up of one layer. Thus, there is a problem that performing such fine tinge adjustment is difficult.

Accordingly, the printed pattern 20A on the optical sheet 16A according to the present embodiment is made up of at least three layers of a lower printed layer 21, a middle printed layer 22, and an upper printed layer 23, that are layered in order on the light-transmitting sheet 16a, as Illustrated in FIG. 1. The lower printed layer 21 and upper printed layer 23 are both white, while the middle printed layer 22 is a color different from white. The middle printed layer 22 of a different color preferably is of a color that is in a complementary color relation as to the uneven chromaticity. Color shift due to white paint can be corrected by providing the middle printed layer 22 of a color that is in a complementary color relation as to uneven chromaticity between the lower printed layer 21 that is white and the upper printed layer 23 that is white.

Thus, in a case of performing correction at the middle printed layer 22 that is the middle layer of multiple layers, even if the tinge of the middle layer is greatly shifted toward blue for example, the overall printed pattern 20A only slightly gains a bluish tinge due to the middle layer being interposed between white layers. Accordingly, color shift can be readily corrected.

Note that in a case of correction of uneven chromaticity by such tinge adjustment of a coated layer being performed on the entirety of paint used in a printed pattern made up of one layer, extremely fine tinge adjustment becomes necessary, as described above. Uneven chromaticity is on a level of slight shifting from white, such as a yellow-tinged white for example. However, human eyes sensitively sense even slight change in chromaticity. Accordingly, in a case of correcting this color shift in a coated layer of one layer, an extremely slight bluish tinge will be added to the white paint. Adding just an extremely slight bluish tinge markedly changes the appearance of the tinge of the backlight. Change in chromaticity of light transmitted through the printed pattern is also observed. In this case, light scattered and reflected within the printed pattern many times is corrected toward a bluish tinge many times, so the effects are particularly great. As a result, slight shift in tinge adjustment has great effects, and tinge adjustment of the printing paint is extremely difficult.

In comparison with this, the middle printed layer 22 is interposed between the upper printed layer 23 and lower printed layer 21 which are white layers in the present embodiment, so even if the tinge of the middle printed layer 22 is greatly shifted toward blue, the overall printed pattern 20A only has a slight bluish tinge.

Now, the upper printed layer 23 and lower printed layer 21 each are single layers in the above-described printed pattern 20A. However, this is not necessarily restrictive, and the upper printed layer 23 and lower printed layer 21 each can be multiple layers.

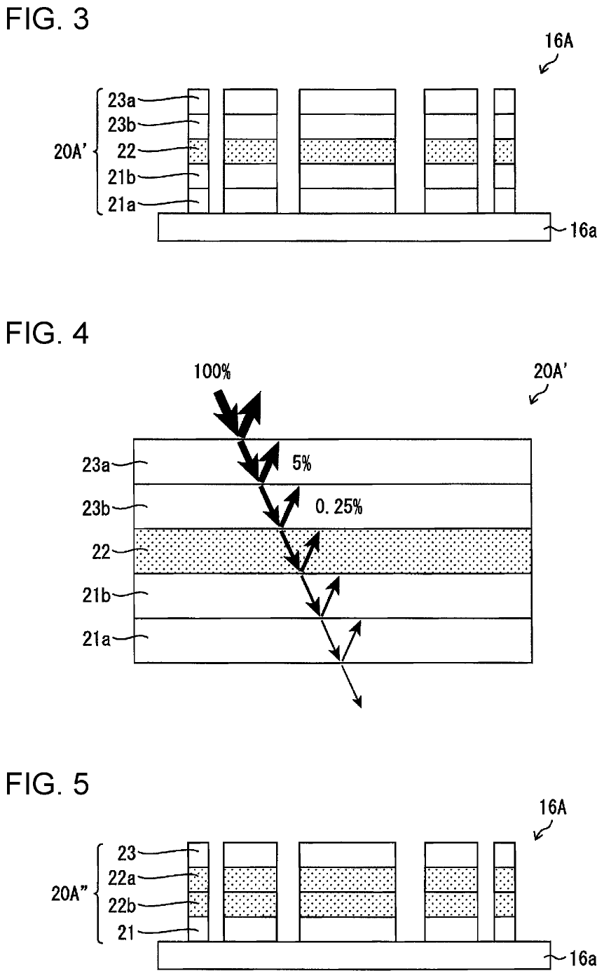

The configuration of a printed pattern 20A′, which is a modification where the upper printed layer 23 and lower printed layer 21 each are multiple layers, will be described with reference to FIG. 3 and FIG. 4. FIG. 3 is a sectional view of principal portions, illustrating the configuration of the printed pattern 20A′ of a modification on the optical sheet 16A according to the present embodiment. FIG. 4 is a sectional view of principal portions, illustrating the configuration of the printed pattern 20A′, illustrating the amount of transmission of light.

The upper printed layer 23 in the printed pattern 20A′ of the optical sheet 16A. according to the present embodiment is provided with a first upper printed layer 23a and a second upper printed layer 23b, in that order from above, as illustrated in FIG. 3. Also, the lower printed. layer 21 is provided with a first lower printed layer 21a and a second lower printed layer 21b, in that order from below. Specifically, provided are “first upper printed layer 23a: white”, “second upper printed layer 23b: white”, “middle printed layer 22: bluish white”, “first lower printed layer 21a: white”, and “second. lower printed layer 21b: white”. The “first upper printed layer 23a: white” and “second upper printed layer 23b: white”, and the “first lower printed layer 21a: white” and “second lower printed layer 21b: white” are each white of the same tinge.

In this case, the light that enters from either the upper side or lower side of the printed pattern 20A′ is transmitted through two layers of white before reaching the middle printed layer 22 with a bluish tinge. In a case where the transmittance of the white layer that is the first upper printed layer 23a is 5% at this time, for example, light entering the middle printed layer 22 that is a white layer with a bluish tinge is approximately 0.25% of the light originally entering the printed pattern. 20A′. Consequently, only approximately 0.25% of the light that originally entered the printed pattern 20A′ is affected by the middle printed layer 22 that is a color adjusting layer. Note that FIG. 4 has been simplified to facilitate description. In the first place, light is not affected by reflection and the like only at the interface of layers, and is constantly affected by the layer through which it is traveling. Also, in a case of having actually coated in layers, there are no interfaces. Accordingly, to say that transmission of one layer is 5% is to say that part of the light continues to be constantly scattered while traveling through that layer, and 5% of the light remains without having been scattered at the point of having traveled the thickness of the layer. On the other hand, light that has been scattered in the layer and is he ding in the direction of reflection. becomes reflected light. Additionally, there also exists light that is absorbed by the ink of the printed pattern 20A′.

Thus, in the printed pattern 20A′ where the upper printed layer 23 and lower printed layer 21 each are formed as multiple layers, effects on the backlight chromaticity of the overall printed pattern 20A′ can be kept small even if the tinge of the middle printed layer 22 that is a color adjusting layer is greatly changed. Accordingly, tinge adjustment of the printing paint becomes easy, and more precise correction of uneven chromaticity is enabled.

Note that while the middle printed layer 22 that is a chromaticity adjusting layer is only one layer in the above-described printed patterns 20A and 20A′, this is not necessarily restrictive, and the middle printed layer 22 can be formed as multiple layers.

A printed pattern 20A″ where the middle printed layer 22 is multiple layers will be described with reference to FIG. 5. FIG. 5 is a sectional view of principal portions, illustrating the configuration of the printed pattern 20A″ of another modification on the optical sheet 162 according to the present embodiment.

The printed pattern 20A″ may also be made with multiple middle printed layers 22 existing, such as a first middle printed layer 22a and a second middle printed layer 22b serving as chromaticity adjusting layers, as illustrated in FIG. 5.

Assumption will be made that the printed pattern 20A made up of a layered structure of “upper printed layer 23: white”, “middle printed layer 22: blue”, and “lower printed layer 21: white” is fabricated as described above, in order to remedy yellow chromatic unevenness, for example. There are cases where, as a result of having used the printed pattern 20A having such a layered structure, the bluish tinge of the printed pattern 20A is insufficient, so while the yellow chromatic unevenness is reduced, yellow chromatic unevenness still remains.

In this case, one conceivable technique for remedy is to readjust the tinge of the blue layer that is the middle printed layer 22. Specifically, the tinge of the blue layer that is the middle printed layer 22 is made to be darker.

However, a method other than this can be conceived where one more blue layer of the same tinge is added, to make the printed pattern 20A″ made up of the layer structure of “upper printed layer 23: white”, “first middle printed layer 22a: blue”, “second middle printed layer 22b: blue”, and “lower printed. layer 21: white”, as illustrated in FIG. 5. The “first middle printed layer 22a: blue” and the “second middle printed layer 22b: blue” are blue of the same tinge.

According to the configuration of this printed pattern 20A″, the overall tinge of the printed pattern 20A″ can be adjusted without changing he tinge of the blue layer.

Note that using a white layer with a bluish tinge for the middle printed layer 22 that is the middle layer in the present embodiment is one example, and using layers of other colors is also conceivable.

In this way, the optical sheet 16A according to the present embodiment is provided with the white-color printed pattern 20A on the light-transmitting sheet 16a in order to transmit or reflect light from the LEDs 12 serving as light sources. The printed pattern 20A is made up of at least the three layers of the lower printed layer 21, middle printed layer 22, and upper printed layer 23 layered on the light-transmitting sheet 16a in that order. Each color tone of the lower printed layer 21 and upper printed layer 23 is white, while the color tone of the middle printed layer 22 is a color that is different from white.

In a case where light enters the white-color printed pattern 20A in the optical sheet 16A of the configuration described above, the light first strikes the white upper printed layer 23 or lower printed layer 21.

Accordingly, the tinge of the middle printed layer 22 can be greatly shifted toward blue, for example, to correct uneven chromaticity at the middle printed layer 22, for example. Even so, the overall printed pattern 20A is only slightly tinged blue, since the middle printed layer 22 is interposed between the upper printed layer 23 and lower printed layer 21 that are white, and effects are small.

Thus, even if the tinge of the middle printed layer 22 that is a color adjusting layer is changed greatly in the optical sheet 16A according to the present embodiment, the effects of chromaticity on the optical sheet 16A including the printed pattern 20A made up of at least three layers can be kept small.

As a result, tinge adjustment of the printing paint of the middle printed layer 22 becomes easy, and more precise correction of uneven chromaticity is enabled.

Accordingly, the optical sheet 16A that can readily suppress occurrence of uneven chromaticity can be provided in a case of providing the white-color printed pattern 20A.

Also, the color tone of the middle printed layer 22, first middle printed layer 22a, and second middle printed layer 22b of the optical sheet 16A according to the present embodiment is a color having a complementary color relation as to the color tone of uneven chromaticity. Accordingly, providing the middle printed layer 22, first middle printed layer 22a, and second middle printed layer 22b, having a complementary color relation as to uneven chromaticity between the upper printed layer 23 and lower printed layer 21, enables correction to be made where a color shift away from white is returned no white.

Also, in the optical sheet 16A according to the present embodiment, the color tone of the middle printed layer 22, first middle printed layer 22a, and second middle printed layer 22b is a color with. more of a bluish tinge than white. Light transmitted through or reflected at the white optical sheet 16A many times readily becomes a yellowish white. Accordingly, in the optical sheet 16A according to the present embodiment, the middle printed layer 22, first middle printed layer 22a, and second middle printed layer 22b are made to be a white with more of a bluish tinge than white. Thus, the bluish white has a complementary color relation as to yellowish white. Accordingly, the color shift of the yellowish white can be corrected to be returned to white.

Also, in the optical sheet 16A according to the present embodiment, the first lower printed layer 21a and second lower printed layer 21b, and first upper printed. layer 23a and second upper printed layer 23b are each made up of multiple layers.

Accordingly, light entering the optical sheet 16A is gradually reduced with regard to the amount of light being transmitted or reflected. each time another layer is passed, by the multiple layers of the first lower printed layer 21a and second lower printed layer 21b, and first upper printed layer 23a and second. upper printed layer 23b. Accordingly, the amount of light entering the middle printed layer 22 is small, and the amount of light transmitted or reflected also is small, so the effects of the color tone of the middle printed layer 22 are small. As a result, even if the color tone of the middle printed layer 22 is changed greatly, the effects on the overall optical sheet 16A are small.

Thus, tinge adjustment of the printing paint of the middle printed layer 22 becomes even easier, and even more precise correction of uneven chromaticity is enabled.

Also, in the optical sheet 16A according to the present embodiment, the first middle printed layer 22a and second middle printed. layer 22b are made up of multiple layers. Accordingly, in a case where chromaticity remedying by the middle printed layer 22 that is a single layer is insufficient, forming multiple layers of the middle printed layer 22 enables remedying of chromaticity to be more easily performed. than changing the color tone of the middle printed layer 22 that is a single layer, since all that has to be done is to increase the middle printed layers 22.

Also, the backlight 1 according to the present embodiment has the LEDs 12 that are disposed directly below the display panel and serve as multiple light sources emitting white light, and the optical sheet 16A disposed across the air layer 14 at the emitting face side of the LEDs 12. According to the above configuration, a backlight 1 having the optical sheet 16A that can readily suppress occurrence of uneven chromaticity can be provided in a case of providing the white-color printed pattern 20A.

### Embodiment 2

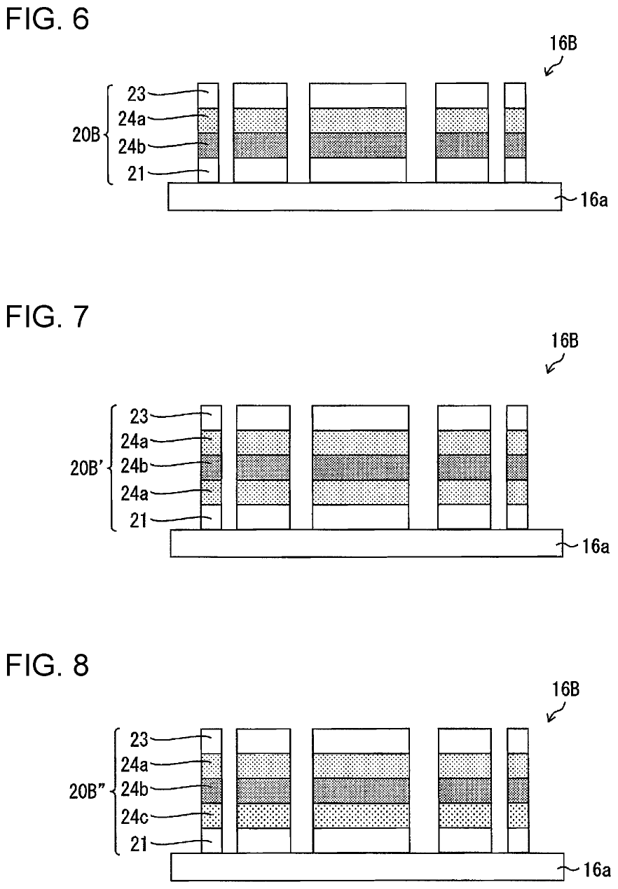

Another embodiment of the present invention will be described below with reference to FIG. 6 through FIG. 8. Note that configurations other than those described in the present embodiment are the same as in Embodiment 1. Also, for the sake of convenience in description, members having the same functions as members illustrated in the drawings for Embodiment 1 are denoted by the same symbols, and description. thereof will be omitted.

The first middle printed layer 22a and second middle printed layer 22b in the printed. pattern 20A″ of the optical sheet 16A according to Embodiment 1 were both bluish white, and were the same color. In contrast with this, a printed pattern 20B of an optical sheet 16B according to the present embodiment differs therefrom with regard to the point that a tinge of a third middle printed layer 24a and a tinge of a fourth middle printed layer 24b differ from each other.

The configuration of the printed pattern 20B of the optical sheet 16B according to the present embodiment will be described with reference to FIG. 6. FIG. 6 is a sectional view of principal portions, illustrating the configuration of the printed pattern 20B on the optical sheet 16B according to the present embodiment.

The printed pattern 20B on the optical sheet 16B according to the present embodiment has the two types of third middle printed layer 24a and fourth middle printed layer 24b as chromaticity adjusting layers, as illustrated in FIG. 6. The third middle printed layer 24a and fourth middle printed layer 24b also differ in tinge from each other. Thus, chromaticity adjusting layers having two or more types of tinge exist in the optical sheet 16B according to the present embodiment.

Specifically, the printed pattern 20B of the optical sheet 16B has “lower printed layer 21: white”, “fourth middle printed layer 24b: strongly bluish white”, “third middle printed layer 24a: slightly bluish white”, and “upper printed layer 23: white”, layered on the light-transmitting sheet 16a in that order, as illustrated in FIG. 6.

For example, an assumption will be made that only the middle printed layer 22 that is a chromaticity adjusting layer having one type of tinge, illustrated in the printed pattern 20A in Embodiment 1, is provided. Assumption will be made regarding such a printed pattern 20A that there is no change in the chromaticity of light transmitted through the printed pattern 20A, but the chromaticity of reflected light has shifted. In this case, there is need to adjust, only the reflectance wavelength distribution while maintaining the transmittance wavelength distribution of the printed pattern 20A in order to remedy the uneven chromaticity of the backlight 1. However, in a case of attempting to perform adjustment just by the middle printed layer 22 that is a chromaticity adjusting layer having one type of tinge, adjusting the reflectance wavelength distribution of the chromaticity adjusting layer changes the transmittance wavelength distribution as well. That is to say, in the technique using only the middle printed layer 22 that is a chromaticity adjusting layer having one type of tinge, individually controlling the transmittance wavelength distribution and reflectance wavelength distribution of the printed pattern 20A is difficult.

Accordingly, in the printed pattern 20B on the optical sheet 16B according to the present embodiment, the “third middle printed layer 24a: slightly bluish white” having the same wavelength transmittance as the middle printed layer 22 of the printed pattern 20A according to Embodiment 1, and the “fourth middle printed layer 24b: strongly bluish white” having the same wavelength transmittance, are combined.

In this printed pattern 20B, even though the wavelength transmittance of the overall printed pattern is equivalent to that of the printed pattern 20A using the middle printed layer 22 that is a chromaticity adjusting layer of one type according to Embodiment 1, the layer configuration differs, so the reflectance wavelength distribution differs. Accordingly, transmittance wavelength distribution and reflectance wavelength distribution can be individually controlled.

Thus, in the optical sheet 16B, the “fourth middle printed layer 24b: strongly bluish white” is adjusted toward blue in order to adjust the tinge of “third middle printed layer 24a: slightly bluish white” to be whiter in the printed pattern 203, using the third middle printed layer 24a and fourth middle printed layer 24b that are chromaticity adjusting layers of two types, and the wavelength transmittance of the overall printed pattern 203 can thus be kept without change. Accordingly, the wavelength reflectance can be adjusted without changing the wavelength transmittance.

Note that in the optical sheet 165 according to the present embodiment, a printed pattern 20B′ having three layers of chromaticity adjusting layers may be made as a modification, as illustrated in FIG. 7. FIG. 7 is a sectional view of principal portions, illustrating the configuration of the printed pattern 20B′ of a modification on the optical sheet 16B according to the present embodiment.

The printed pattern 20B′of the modification on the optical sheet 163 according to the present embodiment has “lower printed layer 21: white”, “third middle printed layer 24a: slightly bluish white”, “fourth middle printed layer 24b: strongly bluish white”, “third middle printed layer 24a: slightly bluish white”, and “upper printed layer 23: white”, layered on the light-transmitting sheet 16a in that order, as illustrated in FIG. 7. The two “third middle printed layers 24a: slightly bluish white” are layers having the same tinge as each other.

In the printed pattern 20B′ having the above configuration, even though the wavelength transmittance of the overall printed pattern 20B′ is equivalent to that of the printed pattern 20A using the middle printed layer 22 that is a chromaticity adjusting layer of one type, the layer configuration differs, so the reflectance wavelength distribution differs.

That is to say, light that has entered the upper printed layer 23 that is a white layer in the printed pattern 20B° and been. transmitted through the upper printed layer 23 enters the third middle printed layer 24a that is a slightly bluish white layer, and thereafter only the light that has been. transmitted through the third middle printed layer 24a enters the fourth middle printed layer 24b that is a strongly bluish white layer.

As a result, the printed pattern 20B′ that has wavelength transmittance equivalent to that of printed pattern 20A having only the middle printed layer 22 that is a chromaticity adjusting layer of one type, but has different wavelength reflectance, can be fabricated in the present embodiment.

In this way, the printed pattern 20B according to the present embodiment takes advantage of the fact that transmitted light is transmitted through all layers, but reflected light is not affected by layers on the deeper side than the layer at which it was reflected. Using chromaticity adjusting layers having two or more types enables the wavelength transmittance and wavelength reflectance of the printed patterns 20B and 20B′ to be individually adjusted.

Note that the printed pattern 20B illustrated in FIG. 6 and the printed pattern 20B° illustrated in FIG. 7 is one example, and for example a printed pattern 20B″ configured of chromaticity adjusting layers having three types of tinge, as illustrated in FIG. 8, is also conceivable. FIG. 8 is a sectional view of principal portions, illustrating the configuration of a printed pattern 20B″ of a modification on the optical sheet 16B according to the present embodiment.

The printed pattern 20B″ has “lower printed layer 21: white”, “fifth middle printed layer 24c: white tinged with third shade”, “fourth middle printed layer 24b: white tinged with second shade”, “third middle printed layer 24a: white tinged with first shade”, and “upper printed layer 23: white”, layered on the light-transmitting sheet 16a in that order, as illustrated in FIG. 8.

Thus, wavelength transmittance and wavelength reflectance can be individually adjusted in the printed pattern 20B″ configured of the third middle printed layer 24a, fourth middle printed. layer 24b, and fifth middle printed layer 24c, which are chromaticity adjusting layers having three types of tinge, according to this configuration.

In this way, the third middle printed layer 24a, fourth middle printed layer 24b, and fifth middle printed layer 24c are made up of multiple layers in the optical sheet 16B according to the present embodiment, and also the color tones of the third middle printed layer 24a, fourth middle printed layer 24b, and fifth middle printed layer 24c, which are multiple layers, are different colors from each other.

In the optical sheet 16B of the configuration described above, transmitted light is transmitted through all layers, but reflected light is not affected by layers on the deeper side than the layer at which it was reflected. The optical sheet 16B according to the present embodiment thus takes advantage of this, and uses the third middle printed layer 24a, fourth middle printed layer 24b, and fifth middle printed layer 24c, which are chromaticity adjusting layers having two or more types, as middle printed layers. This enables the wavelength transmittance and wavelength reflectance of the printed patterns 20B, 20B′, and 20B″ to be individually adjusted.

### Embodiment 3

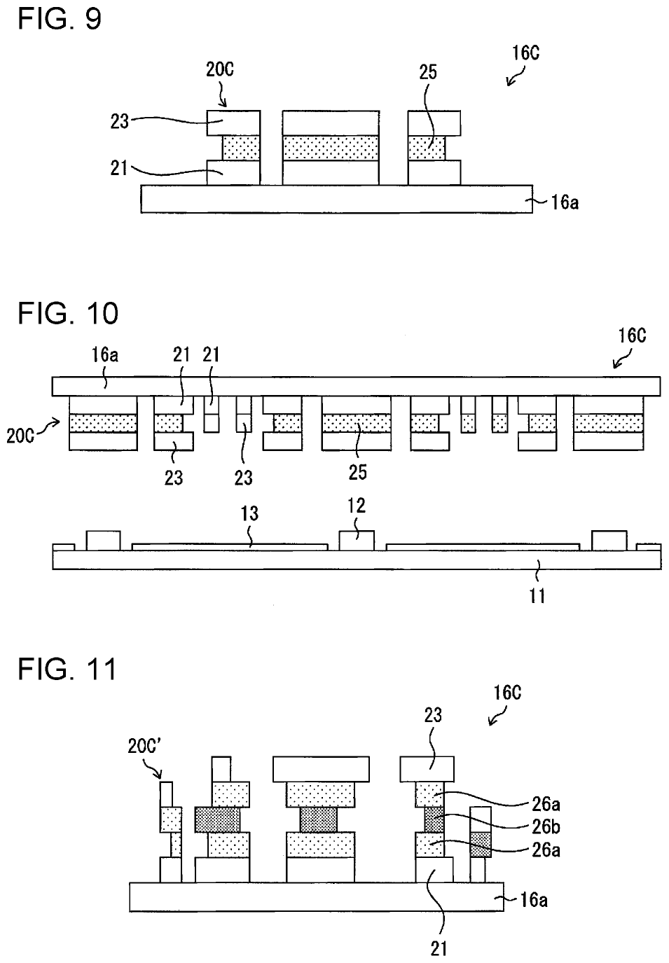

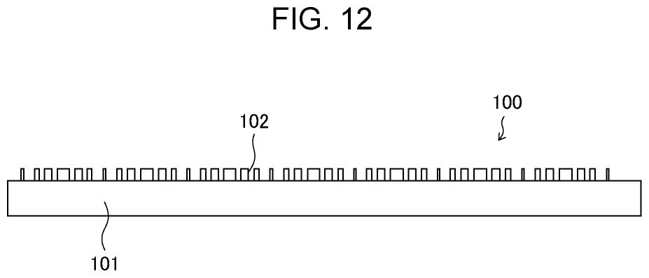

Yet another embodiment of the present invention will be described below with reference to FIG. 9 through FIG. 11. Note that configurations other than those described in the present embodiment are the same as in Embodiments 1 and 2. Also, for the sake of convenience in description, members having the same functions as members illustrated in the drawings for Embodiments 1 and 2 are denoted by the same symbols, and description thereof will be omitted.

An optical sheet 16C according to the present embodiment differs from the optical sheets 16A and 16B with regard to the point that, in a printed pattern 200, the printed pattern shape of at least one layer of the lower printed layer 21, a middle printed layer 25, and the upper printed layer 23 differs from the other printed pattern shapes.

The configuration of the printed pattern 20C of the optical sheet 160 according to the present embodiment will be described. with reference to FIG. 9 and FIG. 10. FIG. 9 is a sectional view of principal portions, illustrating basic configuration of the printed pattern 20C on the optical sheet 16C according to the present embodiment. FIG. 10 is a sectional view of principal portions, illustrating the configuration of the printed pattern 200 based on a relation with the LED 12 on the optical sheet 16C.

The pattern shape of printing of at least one coated layer differs from the pattern shape of printing of the other coated layers in the printed pattern 20C of the optical sheet 160 according to the present embodiment, as illustrated in FIG. 9. In other words, two or more types of printed pattern shapes of layers exist within the one printed pattern 200.

Specifically, the lower printed layer 21 and upper printed layer 23 have the same printed pattern shape, for example, but the printed pattern shape of the middle printed layer 25 differs from the printed pattern shapes of the lower printed layer 21 and upper printed layer 23, as illustrated in FIG. 9. The reflectance characteristics and transmittance characteristics can he changed depending on the location on the printed pattern, by changing the printed pattern shape among the layers in this way.

Now, the degree of change in printed pattern shapes of the layers has a relation with the position of the LED 12. For example, in the printed pattern 200 of the optical sheet 16C, the three layers of “lower printed layer 21: white”, “middle printed layer 25: bluish white”, and “upper printed layer 23: white” are provided in the vicinity of directly above the LED 12, and the shapes are all the same, as illustrated in FIG. 10. However, at locations away from directly above the LED 12, there are only the two layers of “lower printed layer 21: white” and “upper printed layer 23: white”. As a result, the shape of the middle printed layer 25 differs from that of the lower printed layer 21 and upper printed layer 23.

According to this configuration, entering the printed patterns in the vicinity of directly above the LED 12 is subjected to chromaticity adjustment by “middle printed layer 25a: bluish white”. However, light entering the printed patterns at locations away from directly above the LED 12 is not subjected to chromaticity adjustment, due to being “lower printed layer 21: white” and “upper printed layer 23: white”.

Using such a printed pattern 200 enables marked remedying of uneven chromaticity in a backlight exhibiting uneven chromaticity where there is marked yellowing only in the vicinity of directly above the LED 12, for example.

Direct backlights exhibit strong uneven chromaticity depending on locations. Accordingly, using the printed pattern 200 where the layer configuration differs depending on the location of the LED 12 makes it easier to remedy uneven chromaticity. Note that the printed pattern 200 illustrated in FIG. 9 and FIG. 10 is one example, and that other modifications can be configured.

For example, the shapes of each of “lower printed layer 21: white”, “sixth middle printed layer 26a: slightly bluish white”, “seventh middle printed layer 26b: strongly bluish white”, “sixth middle printed layer 26a: slightly bluish white”, and “upper printed layer 23: white” can be changed in a multi-laver structure printed pattern 20C′ in the optical sheet 16C, as illustrated in FIG. 11. Thus, the printed pattern. 20C′ having three or more types of printed pattern shapes can be made. Also, in this case, a change may be made to make the shape of the outermost layer “upper printed layer 23: white” larger.

Note that while the lower printed layer 21 and upper printed layer 23 have the same shape in the printed pattern. 20C in the above description, this is not necessarily restrictive in an aspect of the present invention, and the shapes of the lower printed layer 21 and upper printed layer 23 may be different from each other.

In this way, at the printed pattern shape of at least one layer of the lower printed layer 21, middle printed layer 25, and upper printed layer 23 of the optical sheet 16C according to the present embodiment differs from the other printed pattern shapes.

Accordingly, reflectance characteristics and transmittance characteristics can be changed depending on the location on the printed pattern 20C, by changing the printed pattern shapes among the lower printed layer 21, middle printed layer 25, or upper printed layer 23.

As a result, using the optical sheet 165 according to the present embodiment enables marked remedying of partial uneven chromaticity in an optical sheet exhibiting uneven chromaticity where there is marked yellowing only in the vicinity of directly above the LED 12, for example.

### Summarization

An optical sheet 16A according to a first aspect of the present invention is an optical sheet where a white-color printed pattern 20A, 20A′, 20A″ is provided on a light-transmitting sheet 16a to transmit or reflect light. from a light source (LED 12), where the printed pattern 20A, 20A′, 20A″ is made up of at least three layers of a lower printed layer (lower printed layer 21, first lower printed layer 21a and second lower printed layer 21b), a middle printed layer (middle printed layer 22, first middle printed layer 22a and second middle printed layer 22b), and an upper printed layer (upper printed layer 23, first upper printed layer 23a and second upper printed layer 23b) that are layered in order on the light-transmitting sheet 16a. Each color tone of the lower printed layer (lower printed layer 21, first lower printed layer 21a and second lower printed layer 21b) and the upper printed layer (upper printed layer 23, first upper printed layer 23a and second upper printed layer 23b) is white, while a color tone of the middle printed layer (middle printed layer 22, first middle printed layer 22a and second middle printed layer 22b) is a color different from white.

The optical sheet according to an aspect of the present invention is provided with the white-color printed pattern on the light-transmitting sheet to prevent the light source emitting light from appearing as a hotspot. Accordingly, when transmitting or reflecting light from the light source, the light is scattered at the printed pattern, thereby suppressing uneven brightness, and preventing the light source from appearing as a hotspot.

Now, there are cases where it is more preferable to adjust a color tone of the printed pattern in accordance with a color tone and so forth of the light source, and in such cases, the color tone of an ink of the printed pattern is changed to a color tone slightly shifted from white.

However, if light is transmitted through or reflected at an optical sheet many times, the optical sheet being a sheet where the color tone of the ink of the printed pattern of one layer has been changed to a color tone slightly shifted from white, the chromaticity of the light changes. Also, the number of times of transmission or the number of times of reflection of light differs from each other depending on the location of the optical sheet, so there is a problem that uneven chromaticity occurs as a result.

Accordingly, in the optical sheet according to an aspect of the present invention, the printed pattern is made up of at least three layers of the lower printed layer, the middle printed layer, and the upper printed layer that are layered in order on the light-transmitting sheet, and each color tone of the lower printed layer and the upper printed layer is white, while the color tone of the middle printed layer is a color different from white.

In a case where light enters the printed pattern in the optical sheet of the above configuration, the light first strikes the upper printed layer or the lower printed layer that are white.

Accordingly, a tinge of the middle printed layer can be greatly shifted toward blue for example, to correct uneven chromaticity at the middle printed layer, for example. Even so, the overall printed pattern is only slightly tinged blue, since the middle printed layer is interposed between the upper printed layer and lower printed layer that are white, so effects are small.

Thus, even if the tinge of the middle printed layer that is a color adjusting layer is changed greatly in the optical sheet according to an aspect of the present invention, the effects on chromaticity of the optical sheet including the printed pattern made up of at least three layers can be kept small.

As a result, tinge adjustment of the printing paint of the middle printed layer becomes easy, and more precise correction of uneven chromaticity is enabled.

Accordingly, an optical sheet can be provided that can readily suppress occurrence of uneven chromaticity in a case of providing a white-color printed pattern.

In the optical sheet 16A according to a second aspect of the present invention, the color tone of the middle printed layer (middle printed layer 22, first middle printed layer 22a and second middle printed layer 22b) preferably is a color that is in a complementary color relation as to a color tone of uneven chromaticity.

Accordingly, providing the middle printed layer of a color having a complementary color relation as to uneven chromaticity between the upper printed layer and lower printed layer enables correction to be made where a color shift away from white is returned to white.

In the optical sheet 16A according to a third aspect of the present invention, the color tone of the middle printed layer (middle printed layer 22, first middle printed layer 22a and second middle printed layer 22b) preferably is a color with more of a bluish tinge than white.

Light transmitted through or reflected at the white optical sheet many times readily becomes a yellowish white. Accordingly, in the optical sheet according to an aspect of the present embodiment, the middle printed layer is made to be a white with more of a bluish tinge than white. Thus, the bluish white has a complementary color relation as to yellowish white. Accordingly, the color shift of the yellowish white can be corrected to be returned to white.

In the optical sheet 16A according to a fourth aspect of the present invention, the lower printed layer (first lower printed layer 21a and second lower printed layer 21b) and the upper printed layer (first upper printed layer 23a and second upper printed layer 23b) each may be made up of multiple layers.

Accordingly, light entering the optical sheet is gradually reduced with regard to the amount of light being transmitted or reflected each time another layer is passed, by the lower printed layer and upper printed layer made up of multiple layers. Accordingly, the amount of light entering the middle printed layer is small, and the amount of light transmitted or reflected also is small, so the effects of the color tone of the middle printed layer are small. As a result, even if the color tone of the middle printed layer is changed greatly, the effects on the overall optical sheet are small.

Accordingly, tinge adjustment of the printing paint of the middle printed layer becomes even easier, and even more precise correction of uneven chromaticity is enabled.

In the optical sheet 16A according to a fifth aspect of the present invention, the middle printed layer (first middle printed layer 22a and second middle printed layer 22b) may be made up of multiple layers.

Accordingly, in a case where chromaticity remedying by the middle printed layer that is a single layer is insufficient, making the middle printed layer to be multiple layers enables remedying of chromaticity to be more easily performed than changing the color tone of the middle printed layer that is a single laver, since all that has to be done is to increase the middle printed layers.

In the optical sheet 16B according to a sixth aspect of the present invention, the middle printed layer (third middle printed layer 24a, fourth middle printed layer 24b, and fifth middle printed layer 24c) may be made up of multiple layers, and the color tones of the multiple layers of the middle printed layer (third middle printed layer 24a, fourth middle printed layer 24b, and fifth middle printed layer 24c) may each be different colors from each other.

In the optical sheet of the above configuration, transmitted light is transmitted through all layers, but reflected light is not affected by layers on the deeper side than the layer at which it was reflected. Accordingly, the optical sheet according to an aspect of the present invention takes advantage of this fact, and uses chromaticity adjusting layers of two types or more as the middle printed layer. This enables the wavelength transmittance and wavelength reflectance of the printed pattern to be individually adjusted.

In the optical sheet according to a seventh aspect of the present invention, a printed pattern shape of at least one layer of the lower printed layer, middle printed layer, and upper printed layer may be different from another printed pattern shape.

Accordingly, reflectance characteristics and transmittance characteristics can be changed depending on the location on the printed pattern, by changing the printed pattern shapes among the lower printed layer, middle printed layer, or upper printed layer.

As a result, using the optical sheet according to this configuration enables marked remedying of partial uneven chromaticity in an optical sheet exhibiting uneven chromaticity where there is marked yellowing only in the vicinity of directly above the light source, for example.

A backlight according to an eighth aspect of the present invention includes multiple light sources that are disposed immediately below a display panel and that emit white light, and the optical sheet provided at an emission face side of the light source across an air layer.

According to the above configuration, a backlight having an optical sheet can be provided that can readily suppress occurrence of uneven chromaticity in a case of providing a white-color printed pattern.

Note that the present invention is not restricted to the above-described embodiments. Various modifications may be made within the scope set forth in the Claims, and embodiments obtained by appropriately combining technical means disclosed in each of different embodiments are also encompassed by the technical scope of the present invention. Further, new technical features can. be formed by combining technical means disclosed in each of the embodiments.

### REFERENCE SIGNS LIST

1 backlight
11 LED substrate
12 LED (light source)
13 reflection sheet
14 air layer
16A, 16B, 16C optical sheet
16a light-transmitting sheet
20A, 20A′ printed pattern
20B, 20B′, 205″ printed pattern
20C, 20C′ printed pattern
21 lower printed layer
21a first lower printed layer (lower printed layer)
21b second lower printed layer (lower printed. layer)
22 middle printed layer
22a first middle printed layer (middle printed layer)
22b second middle printed layer (middle printed layer)
23 upper printed layer
23a first upper printed layer (upper printed layer)
23b second upper printed layer (upper printed. layer)
24a third middle printed layer (middle printed layer)
24b fourth middle printed layer (middle printed layer)
24c fifth middle printed layer (middle printed layer)
25 middle printed layer
26a sixth middle printed layer (middle printed layer)
26b seventh middle printed layer (middle printed layer)

1. An optical sheet where a white-color printed pattern is provided on a light-transmitting sheet to transmit or reflect light from a light source,
wherein the printed pattern is made up of at least three layers of a lower printed layer, a middle printed layer, and an upper printed layer that are layered in order on the light-transmitting sheet,
wherein each color tone of the lower printed layer and the upper printed layer is white, and
wherein a color tone of the middle printed layer is a color different from white.

2. The optical sheet according to claim 1, wherein the color tone of the middle printed layer is a color that is in a complementary color relation as to a color tone of uneven chromaticity.

3. The optical sheet according to claim 1, wherein the color tone of the middle printed layer is a white with more of a bluish tinge than white.

4. The optical sheet according to claim 1, wherein the lower printed layer and the upper printed layer are each made up of a plurality of layers.

5. The optical sheet according to claim 1, wherein the middle printed layer is made up of a plurality of layers.

6. The optical sheet according to claim 1, wherein the middle printed layer is made up of a plurality of layers, and color tones of the plurality of layers of the middle printed layer are each different colors from each other.

7. The optical sheet according to claim 1, wherein a printed pattern shape of at least one layer of the lower printed layer, middle printed layer, and upper printed layer is different from another printed pattern shape,

8. A backlight, comprising:
a plurality of light sources that are disposed immediately below a display panel and that emit white light; and
the optical sheet according to claim 1, provided at an emission face side of the light source, across an air layer.
